(19) United States
(12) Patent Application Publication
(10) Pub. No.: US 2024/0331918 A1
(43) Pub. Date: Oct. 3, 2024

(54) INDUCTOR

(71) Applicant: Murata Manufacturing Co., Ltd., Kyoto-fu (JP)

(72) Inventors: Takeshi KOBAYASHI, Nagaokakyo-shi (JP); Daisuke ISHIDA, Nagaokakyo-shi (JP)

(73) Assignee: Murata Manufacturing Co., Ltd., Kyoto-fu (JP)

(21) Appl. No.: 18/583,734

(22) Filed: Feb. 21, 2024

(30) Foreign Application Priority Data
Mar. 28, 2023 (JP) 2023-050967

(51) Int. Cl. H01F 27/255; H01F 27/28; H01F 27/29; H01F 41/02; H01F 41/061

(52) U.S. Cl. CPC H01F 27/255; H01F 27/292; H01F 27/2828; H01F 41/0246; H01F 41/061

(57) ABSTRACT

An inductor includes a coil, a main body, and outer terminals. The coil includes a winding portion formed by winding a flat conducting wire and also includes a pair of extension portions of the conducting wire extended from the winding portion. The main body contains magnetic powder and resin and accommodates the coil. The outer terminals are formed on at least one surface of the main body and connected to respective extension portions. In the inductor, the main body includes a principal surface shaped like a rectangle having sides extending in a first direction and in a second direction, and the principal surface intersects a winding axis of the coil. The main body also includes a pair of first surfaces adjoining the principal surface and extending in the first direction and a pair of second surfaces adjoining the principal surface and extending in the second direction.

### CROSS-REFERENCE TO RELATED APPLICATION

This application claims benefit of priority to Japanese Patent Application No. 2023-050967, filed Mar. 28, 2023, the entire content of which is incorporated herein by reference.

### BACKGROUND

### Technical Field

The present disclosure relates to an inductor.

### Background Art

Japanese Unexamined Patent Application Publication No. 2010-245473 discloses a surface-mount inductor having a molded body that includes a coil formed by winding a conducting wire and a main body made of a sealing material containing resin and magnetic material.

### SUMMARY

This type of inductor has been designed such that an area surrounded by an inner periphery of the coil and an area outside of an outer periphery of the coil in the main body are determined so as to satisfy required values of rated DC superposition current and of DC resistance. However, there have been difficulties in satisfying required characteristics especially in an inductor having a small-size main body even if the above parameters are optimized. Accordingly, an improvement in setting parameters is desired.

According to an aspect of the present disclosure, an inductor includes a coil, a main body, and outer terminals. The coil includes a winding portion formed by winding a flat conducting wire and also includes a pair of extension portions of the conducting wire extended from the winding portion. The main body contains magnetic powder and resin and accommodates the coil. The outer terminals are formed on at least one surface of the main body and connected to respective extension portions. In the inductor, the main body includes a principal surface shaped like a rectangle having sides extending in a first direction and in a second direction, and the principal surface intersects a winding axis of the coil. The main body also includes a pair of first surfaces adjoining the principal surface and extending in the first direction and a pair of second surfaces adjoining the principal surface and extending in the second direction. The main body also includes first side-gap portions formed between an outer periphery of the winding portion and respective first surfaces and second side-gap portions formed between the outer periphery and respective second surfaces. When S1 is an area of the principal surface, WSG is a sum of lengths of respective first side-gap portions in the second direction, LSG is a sum of lengths of respective second side-gap portions in the first direction, S3 is an area surrounded by an inner periphery of the winding portion as viewed in a direction normal to the principal surface, S4 is an area between the outer periphery and a periphery of the main body as viewed in the direction normal to the principal surface, and SG is a value obtained from formula (A) below, K obtained from formula (B) below stays in a range of 70 or more and 110 or less (i.e., from 70 to 110).

$$SG = WSG \times LSG \qquad ( A )$$

$$K = ( S 1 / SG ) \times ( S 4 / S 3 ) \qquad ( B )$$

According to the present disclosure, an inductor having favorable characteristics can be provided.

### BRIEF DESCRIPTION OF THE DRAWINGS

FIG. 1 is a perspective view illustrating an inductor according to Embodiment 1 of the present disclosure, in which the top surface of the inductor is viewed;

FIG. 2 is a perspective view illustrating the inductor of Embodiment 1, in which the bottom surface thereof is viewed;

FIG. 3 is a perspective view illustrating an internal structure of the inductor of Embodiment 1;

FIG. 4 is a schematic diagram illustrating a process of manufacturing the inductor of Embodiment 1;

FIG. 5 is a view schematically illustrating a main body of the inductor of Embodiment 1 as viewed in the direction normal to the top surface thereof;

FIG. 6 is a table summarizing various parameters and calculated values K in simulation based on Example;

FIG. 7 is a table summarizing a relationship between the values K and Isat/Rdc in the simulation based on Example;

FIG. 8 is a graph depicting a relationship between the values K and Isat/Rdc in the simulation based on Example;

FIG. 9 is a perspective view illustrating a main body according to Embodiment 2;

FIG. 10 is a view schematically illustrating the main body of Embodiment 2 as viewed in the direction normal to the top surface thereof;

FIG. 11 is a perspective view illustrating a main body according to Embodiment 3; and

FIG. 12 is a view schematically illustrating the main body, in which the bottom surface thereof is viewed.

### DETAILED DESCRIPTION

### Embodiment 1

An inductor 1 according to Embodiment 1 and a method of manufacturing the inductor 1 will be described.

### General Structure of Inductor

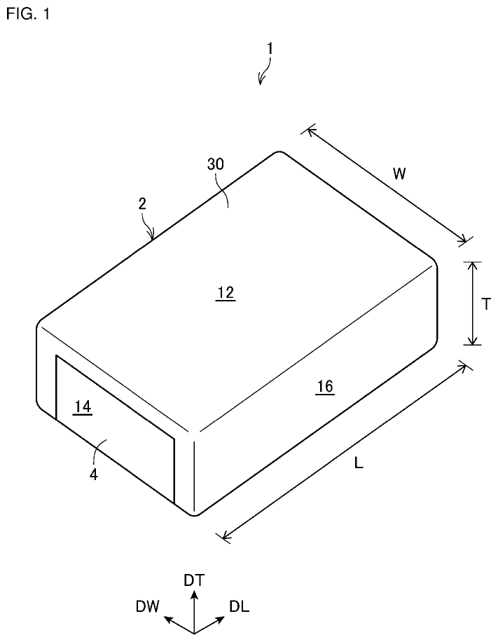

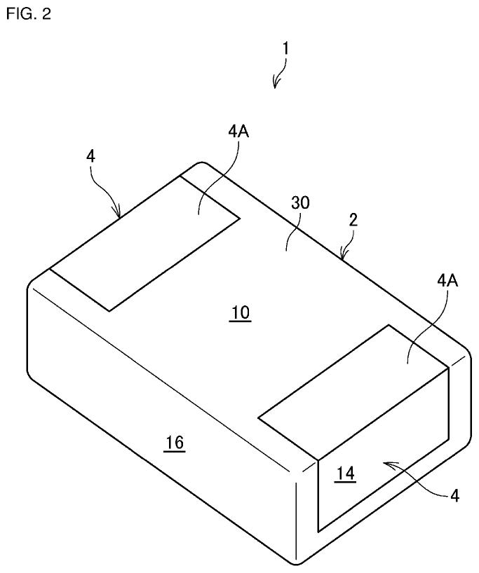

FIG. 1 is a perspective view illustrating the inductor 1 of the present embodiment, in which a top surface 12 of the inductor 1 is viewed. FIG. 2 is a perspective view illustrating the inductor 1, in which a bottom surface 10 thereof is viewed.

The inductor 1 of the present embodiment is configured to serve as a surface-mount component. The inductor 1 includes a main body 2 shaped like a rectangular parallelepiped, which is one type of a hexahedron. The inductor 1 also includes a pair of outer electrodes (i.e., outer terminals) 4 formed on corresponding surfaces of the main body 2.

The bottom surface 10 or the principal surface 10 is defined as a first principal surface of the main body 2 that faces a circuit board (not illustrated) when the inductor 1 is mounted. The top surface 12 or the principal surface 12 is referred to as a “second principal surface” positioned opposite to the bottom surface 10. A pair of surfaces of the main body 2 that orthogonally intersect the bottom surface 10 are referred to as “end surfaces (i.e., second surfaces) 14”. A pair of surfaces of the main body 2 that orthogonally intersect the end surfaces 14 and the bottom surface 10 are referred to as “side surfaces (i.e., first surfaces) 16”. The end surfaces 14 are positioned opposite to each other. The side surfaces 16 are positioned opposite to each other. The bottom surface 10, the top surface 12, the end surfaces 14, and the side surfaces 16 are shaped like rectangles.

As illustrated in FIG. 1, a thickness T of the main body 2 is defined as the distance between the top surface 12 and the bottom surface 10, a width W of the main body 2 is defined as the distance between the side surfaces 16, and a length L of the main body 2 is defined as the distance between the end surfaces 14. In addition, the thickness direction DT is defined as the direction of the thickness T, the width direction (i.e., second direction) DW is defined as the direction of the width W, and the length direction (i.e., first direction) DL is defined as the direction of the length L. Accordingly, the bottom surface 10 and the top surface 12 are parallel to both the width direction DW and the length direction DL, the end surfaces 14 are parallel to both the width direction DW and the thickness direction DT, and the side surfaces 16 are parallel to both the length direction DL and the thickness direction DT. The end surfaces 14 adjoin the bottom surface 10, the top surface 12, and the side surfaces 16. The side surfaces 16 adjoin the bottom surface 10, the top surface 12, and the end surfaces 14.

For example, the inductor 1 as a finished product has a length L of 1.4 mm, a width W of 1.2 mm, and a thickness T of 0.65 mm as nominal dimensions.

In the present specification, a surface extending in the direction DL and in the direction DT is referred to as a “surface LT”, a surface extending in the direction DT and in the direction DW is referred to as a “surface TW”, and a surface extending in the direction DL and in the direction DW is referred to as a “surface LW”. In the inductor 1, a section LT is parallel to the surface LT, a section TW is parallel to the surface TW, and a section LW is parallel to the surface LW.

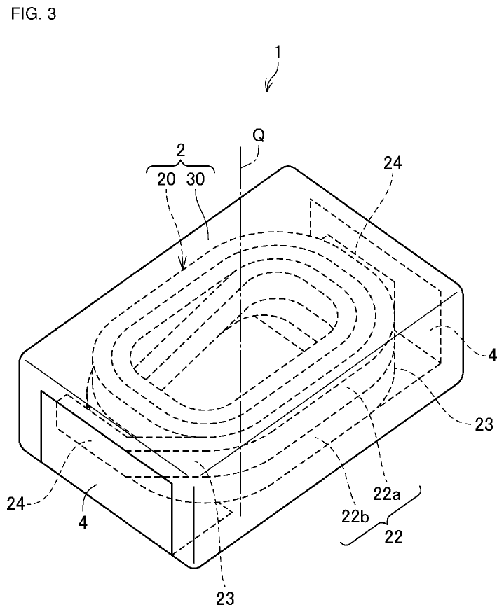

FIG. 3 is a perspective view illustrating an internal structure of the inductor 1.

In the inductor 1, the main body 2 includes a coil conductor (i.e., coil) 20 and a core 30 that is shaped like a hexahedron and in which the coil conductor 20 is buried. The inductor 1 is a molded inductor in which the coil conductor 20 is enclosed in the core 30.

The core 30 is a molded body made by pressure molding in such a manner that magnetic particles (i.e., magnetic powder) are mixed with resin and the mixed powder is pressed and heated to have a substantially hexahedron shape with the coil conductor 20 being buried therein.

The magnetic particles of the present embodiment are made of a soft magnetic material. The magnetic particles include two different grain types, in other words, first magnetic particles with a larger average grain diameter and second magnetic particles with a smaller average grain diameter. During the pressure molding, the small-diameter second magnetic particles and the resin enter the pore space of the large-diameter first magnetic particles, which can increase the filling factor of the magnetic particles in the core 30 and thereby increase the magnetic permeability of the core 30.

In the present embodiment, the average grain diameter of the metal particles of the first magnetic particles is 20 μm or more and 28 μm or less (i.e., from 20 μm to 28 μm), whereas the average grain diameter of the metal particles of the second magnetic particles is 1 μm or more and 6 μm or less (i.e., from 1 μm to 6 μm). The average grain diameter of the first magnetic particles is preferably 21.4 μm or more and 27.4 μm or less (i.e., from 21.4 μm to 27.4 μm), and the average grain diameter of the second magnetic particles is preferably 1.5 μm or more and 1.8 μm or less (i.e., from 1.5 μm to 1.8 μm). The magnetic particles may include different-type magnetic particles that have an average grain diameter different from those of the first magnetic particles and the second magnetic particles. Accordingly, the magnetic particles may include three or more types of magnetic particles.

The first magnetic particles and the second magnetic particles are metal particles each having an oxide film covering the surface thereof and an insulator film covering the surface of the oxide film. Covering the metal particle with the oxide film and the insulator film can increase the insulation resistance and the withstanding voltage.

In the present embodiment, a powder made of Fe—Si—B amorphous alloy is used for the metal particles of the first magnetic particles. The oxide film of the first magnetic particle is made of two layers, in other words, an SiO layer and a Fe₂SiO₄. The total thickness of the oxide film is 20 nm or more and 155 nm or less (i.e., from 20 nm to 155 nm). The insulator film of the first magnetic particle is made of a phosphate glass, and the thickness is 10 nm or more and 50 nm or less (i.e., from 10 nm to 50 nm).

In the present embodiment, the metal particles of the second magnetic particles are made of carbonyl iron. The oxide film of each second magnetic particle is made of iron oxide formed by oxidizing the surface of the metal particle or the carbonyl iron particle. The insulator film of the second magnetic particle is a product of the sol-gel process using silica. This can increase the surface slippage of the second magnetic particle and thereby cause the second magnetic particles to enter the pore space of the first magnetic particles easily in a step of shaping and solidifying the main body 2 (to be described later). This can increase the density of the magnetic material in the core 30 and thereby increase the relative magnetic permeability of the core 30.

In the first magnetic particles, Fe—Si—Cr alloy powder, Fe—Ni—Al alloy powder, Fe—Cr—Al alloy powder, Fe—Si—Al alloy powder, Fe—Ni alloy powder, or Fe—Ni—Mo alloy powder may be used for the metal particles.

In the first magnetic particle, the insulator film may be made of a phosphate, zinc phosphate, manganese phosphate, glass, or resin.

In the present embodiment, the resin materials used in the mixed powder include bis-phenol A epoxy resin and rubber-modified epoxy resin. This can produce the inductor 1 having a main body 2 with an improved strength and toughness.

In the present embodiment, the magnetic powder of the mixed powder contains 70 wt % or more and 85 wt % or less (i.e., from 70 wt % to 85 wt %) of the first magnetic particles and 15 wt % or more and 30 wt % or less (i.e., from 15 wt % to 30 wt %) of the second magnetic particles with respect to the total weight of the magnetic particles included in the mixed powder. In the present embodiment, the mixed powder contains 2.0 wt % or more and 3.5 wt % or less (i.e., from 2.0 wt % to 3.5 wt %) of the resin with respect to the total weight of the magnetic powder and the resin. Note that the magnetic powder preferably contains 70 wt % or more and 80 wt % or less (i.e., from 70 wt % to 80 wt %) of the first magnetic particles and 20 wt % or more and 30 wt % or less (i.e., from 20 wt % to 30 wt %) of the second magnetic particles. The mixed powder preferably contains 2.7 wt % or more and 30 wt % or less (i.e., from 2.7 wt % to 30 wt %) of the resin.

As illustrated in FIG. 3, the coil conductor 20 includes a winding portion 22 and extension portions 23. In the winding portion 22, a conducting wire is wound spirally around a winding axis Q in two tiers, in other words, in an upper tier and a lower tier, in such a manner that both ends of the conducting wire are positioned at the outer periphery of the winding portion 22 and an upper-tier portion of the conducting wire is connected to a lower-tier portion at the inner periphery of the winding portion 22. An outer-electrode connection region 24 is formed at each extension portion 23. The outer-electrode connection region 24 is part of conducting wire and serves for the connection with an outer electrode, which will be described later. The winding portion 22 includes winding regions 22a and 22b that are stacked in a direction along the winding axis Q. A portion of the wire in the winding region 22a is connected to a portion of the wire in the winding region 22b at the innermost turn of the conducting wire.

The coil conductor 20 is buried in the main body 2 in such a manner that the winding axis Q extends parallel to the thickness direction DT. In other words, the winding axis Q extends parallel to the end surfaces 14 and the side surfaces 16 so as to orthogonally intersect the bottom surface 10 and the top surface 12.

The conducting wire of the coil conductor 20 includes a conductor and a cover layer formed on the surface of the conductor. The conducting wire is a flat wire having a rectangular cross section, and more specifically, the conductor is made of copper and shaped like a belt having a rectangular cross section. The thickness of the conductor is 52 μm or more and 118 μm or less (i.e., from 52 μm to 118 μm), and the width of the conductor is 110 μm or more and 180 μm or less (i.e., from 110 μm to 180 μm). The cover layer includes an insulating layer and a fusing layer. The insulating layer is formed on the surface of the belt-like wire, and the fusing layer is formed on the surface of the insulating layer. The fusing layer is provided to cause adjacent turns of the belt-like wire to adhere to each other in the winding portion 22. For example, the insulating layer is made of polyimide-amide resin and has a thickness of 3 μm. For example, the fusing layer is made of polyamide resin and has a thickness of 1 μm or more and 25 μm or less (i.e., from 1 μm to 25 μm).

The extension portions 23 are extended from the winding portion 22 to respective end surfaces 14. Each extension portion 23 is electrically connected to the corresponding outer electrode 4 via the outer-electrode connection region 24 exposed at each end surface 14.

Each outer electrode 4 is a so-called L-shaped electrode formed so as to extend from each end surface 14 to the bottom surface 10 of the main body 2. Each outer electrode 4 is connected to the corresponding outer-electrode connection region 24 of the coil conductor 20 at each end surface 14, and an extended portion 4A of the outer electrode 4 positioned on the bottom surface 10 (see FIG. 2) is electrically connected to a circuit board using solder or using an appropriate connection technique.

A body protection layer (not illustrated) is formed on the surfaces of the main body 2 except for surface portions for the outer electrodes 4. For example, the body protection layer includes a resin and nano-silica filler, and the resin is made by adding phenoxy resin to novolac resin. The thickness of the body protection layer formed on the surfaces of the main body 2 is 10 μm or more and 30 μm or less (i.e., from 10 μm to 30 μm). The thickness of the body protection layer is preferably 10 μm or more and 20 μm or less (i.e., from 10 μm to 20 μm), and more preferably 15 μm or less.

The inductor 1 configured as described above has improved DC superposition characteristics since the soft magnetic material is used for the magnetic particles. Accordingly, the inductor 1 is used as an electronic component for a heavy-current circuit and as a choke coil for a DC-DC converter or a power circuit. The inductor 1 is also used as a component for an electronic device, such as a personal computer, a DVD player, a digital camera, a TV set, a mobile phone, a smart phone, an in-vehicle electronic device, a medical or industrial device. The application of the inductor 1 is not limited to the above. For example, the inductor 1 can be applied to a tuning circuit, a filter circuit, or a rectifying and smoothing circuit.

### Outline of Manufacturing Process of Inductor

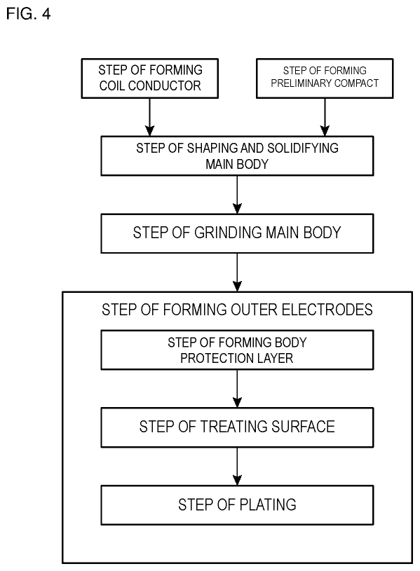

FIG. 4 schematically illustrates a manufacturing process of the inductor 1.

As illustrated in FIG. 4, the manufacturing process of the inductor 1 includes a step of forming the coil conductor, a step of forming a preliminary compact, a step of shaping and solidifying the main body, a step of grinding the main body, and a step of forming the outer electrodes.

In the step of forming the coil conductor, the coil conductor 20 is formed from a conducting wire. In this step, the conducting wire is wound like so-called “alpha-winding” so as to shape the above-described coil conductor 20 having the winding portion 22 and the extension portions 23. The alpha-winding is such that the conducting wire, which serves as the conductor, is wound spirally in two tiers and the extension portions 23, in other words, portions at the start and the end of the winding, are positioned at the outer periphery of the winding portion 22. The number of turns of the coil conductor 20 is not specifically limited.

In the step of forming the preliminary compact, a preliminary compact called a “tablet” is formed.

The preliminary compact is an easy-handling solid body produced by compressing the material of the main body 2 or the above-described mixed powder. In the present embodiment, two types of tablet, in other words, a first tablet and a second tablet, are formed. The first tablet is shaped appropriately (for example, type E or type T) so as to be able to accommodate the coil conductor 20, and the second tablet is shaped appropriately (for example, type I or tabular form) so as to be able to sandwich the coil conductor 20 with the first tablet.

In the step of shaping and solidifying the main body, the first tablet, the coil conductor, and the second tablet are set in a molding die and heated and pressed in the direction of the first tablet and the second tablet coming closer. The first tablet, the coil conductor, and the second tablet are integrated after solidification. In this step, the main body 2 in which the coil conductor 20 is enclosed in the core 30 is produced. Barrel polishing may be carried out to the main body 2 obtained in this step in order to remove fins and the like from the main body 2 or to chamfer the edges of the main body 2.

In the step of grinding the main body, the side surfaces 16 of the main body 2 are ground to adjust the width W of the main body 2. In the step of grinding the main body, the main body 2 is held by a tabular member called a “retainer plate” and is sandwiched by upper and lower whetstones of a grinding machine. In this state, the grinding machine rotates the upper and lower whetstones to grind the side surfaces of the main body 2. In the step of grinding the main body, a first side gap WSG, which is a sum of a width WSG1 and a width WSG2 (to be described later), is reduced to 0.14 mm or smaller.

The step of forming the outer electrodes is a step of forming outer electrodes 4 on the main body 2 and includes a step of forming the body protection layer, a step of treating surface, and a step of plating.

In the step of forming the body protection layer, all surfaces of the main body 2 are coated with an insulating resin.

In the step of treating surface, the surface portions of the core 30 at which the outer electrodes are to be formed are irradiated with laser light, and the surface portions are thereby reformed for electrode formation. The surface portions for electrode formation are regions on the surface of the core 30 in which the outer electrodes 4 are to be formed. The surface portions include portions where the outer-electrode connection regions 24 are exposed. More specifically, within the surface portions for electrode formation, laser light removes the body protection layer on the surface of the main body 2 and the cover layers of the coil conductor 20 in the outer-electrode connection regions 24. The laser light also removes the resin at the surface of the core 30 to expose the magnetic particles from the core 30 and further removes the insulator film on the surface of each magnetic particle exposed. This increases the total exposed area of the metal portions of the magnetic particles per a unit area of the surface of the core 30 in the surface portions for electrode formation compared with the exposed area of the metal portions in other surface portions of the core 30. Note that the surface portions for electrode formation may be cleansed, for example, by etching after the laser irradiation.

In the step of plating, the surface of the core 30 is plated with copper using barrel plating to form a copper layer on the surface portions for electrode formation, which have been irradiated with laser light. In the step of plating, a Ni-plated layer and a Sn-plated layer may be further formed on the copper layer.

The inductor 1 of the present embodiment will be further described in detail. In the following, indexes for evaluating the characteristics of the inductor 1 and parameters affecting these evaluation indexes will be described first, and then preferable range of the parameters will be described.

### Evaluation Indexes for Inductor Characteristics

Rated DC superposition current (hereinafter referred to as “Isat”), DC resistance (hereinafter referred to as “Rdc”), as well as inductance, are important as performance indexes of the inductor 1. Isat is a current value exhibited by the inductor 1 when the inductance of the inductor 1 decreases, due to the magnetic saturation, from the initial value by a predetermined percentage. In the present embodiment, the predetermined percentage is set to 30%. Rdc is a resistance exhibited by the inductor 1 when direct current flows through the inductor 1. In general, the inductor 1 is regarded as having better characteristics as Isat is greater and Rdc is smaller. Accordingly, in the evaluation of the present embodiment, the greater the value Isat/Rdc, the better the characteristics of the inductor 1.

### Parameters

In the inductor 1, major parameters that affect Isat/Rdc include a total area S1, an outer area S4, an inner area S3, a first side gap WSG, and a second side gap LSG, which are described below.

The total area S1 is the area of a principal surface, in other words, either the top surface 12 or the bottom surface 10. Note that the top surface 12 and the bottom surface 10 are shaped like rectangles having respective sides extending in the direction DW and in the direction DL. Accordingly, the total area S1 can be obtained as a product of the width W and the length L of the main body 2.

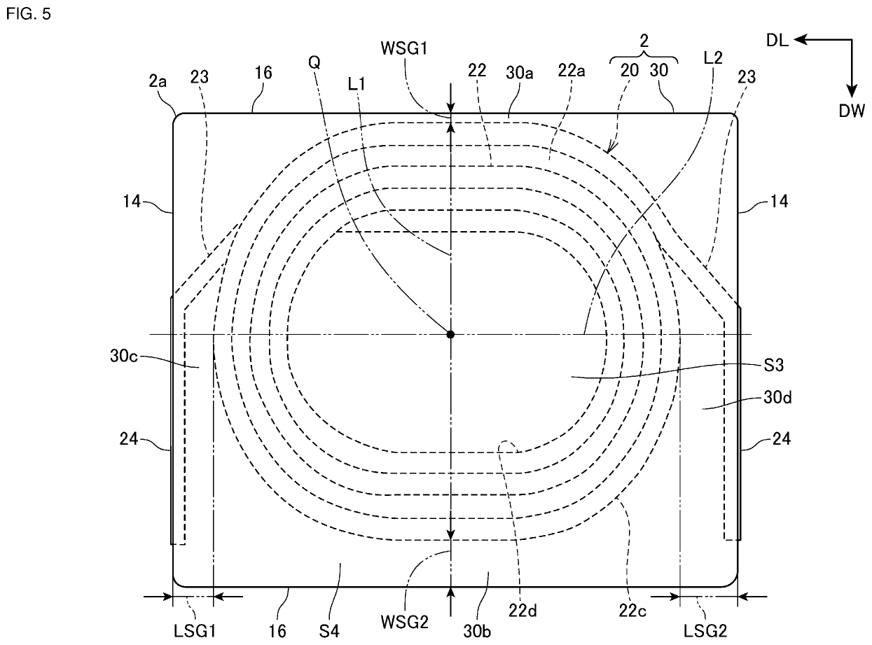

FIG. 5 is a view schematically illustrating the main body 2 as viewed in the direction normal to the top surface 12 thereof. For example a view corresponding to FIG. 5 can be obtained using radiography.

In the present embodiment, the main body 2 is shaped like a rectangular parallelepiped. The area of the top surface 12 or the bottom surface 10 is substantially equal to the area surrounded by a periphery 2a of the main body 2 when the main body 2 is viewed through in the direction normal to the top surface 12 as illustrated in FIG. 5. Accordingly, the total area S1 can be regarded as the area surrounded by the periphery 2a of the main body 2 when the top surface 12 is viewed normal thereto.

The outer area S4 is the area of a region between an outer periphery 22c of the winding portion 22 and the periphery 2a of the main body 2 when the main body 2 is viewed through in the direction normal to the top surface 12. The outer periphery 22c of the winding portion 22 is the outward-facing side of the outermost turn among turns in winding regions 22a and 22b when the main body 2 is viewed through in the direction normal to top surface 12. Accordingly, the outer periphery 22c may be formed by both the outermost turn in the winding region 22a and the outermost turn in the winding region 22b.

The inner area S3 is an area surrounded by an inner periphery 22d of the winding portion 22 when the main body 2 is viewed through in the direction normal to the top surface 12. The inner periphery 22d of the winding portion 22 is the inward-facing side of the innermost turn among turns in winding regions 22a and 22b when the main body 2 is viewed through in the direction normal to top surface 12. Accordingly, the inner periphery 22d may be formed by both the innermost turn in the winding region 22a and the innermost turn in the winding region 22b.

The outer area S4 and the inner area S3 can be obtained, for example, by measuring corresponding areas on an X-ray image of the main body 2 taken in the direction normal to the top surface 12. The outer area S4 and the inner area S3 are necessary for obtaining a value S2 in the formula (1) described later. The value S2 is obtained by dividing the outer area S4 by the inner area S3. Accordingly, in the calculation of the value S2, it is not necessary to determine the outer area S4 and the inner area S3 separately. The value S2 can be directly obtained by calculating the ratio of the area corresponding to the outer area S4 to the area corresponding to the inner area S3 from the above-described X-ray image.

The first side gap WSG is a sum of a width WSG1 and a width WSG2 of two first side-gap portions 30a and 30b formed between the outer periphery 22c of the winding portion 22 and respective side surfaces 16 of the main body 2. The first side-gap portions 30a and 30b are portions of the core 30. The widths WSG1 and WSG2 are lengths of the first side-gap portions 30a and 30b in the direction DW. More specifically, the width WSG1 of the first side-gap portion 30a is defined as a minimum distance in the direction DW between the outer periphery 22c of the winding portion 22 and one of the side surfaces 16 when the main body 2 is viewed through in the direction normal to the top surface 12. Similarly, the width WSG2 of the first side-gap portion 30b is defined as a minimum distance in the direction DW between the outer periphery 22c of the winding portion 22 and the other one of the side surfaces 16 when the main body 2 is viewed through in the direction normal to the top surface 12.

Alternatively, for example, the widths WSG1 and WSG2 can be obtained by measuring the distances, along an imaginary line L1, between the outer periphery 22c of the winding portion 22 and the corresponding side surfaces 16 when the main body 2 is viewed through in the direction normal to the top surface 12 as illustrated in FIG. 5. The imaginary line L1 is an imaginary straight line extending in the direction DW so as to pass through the winding axis Q of the winding portion 22 when the main body 2 is viewed through in the direction normal to the top surface 12. The results obtained by measuring the widths WSG1 and WSG2 in this manner can be close enough to the minimum distances in the direction DW between the outer periphery 22c of the winding portion 22 and respective side surfaces 16 when the main body 2 is viewed through in the direction normal to the top surface 12. Note that the position of the winding axis Q when the main body 2 is viewed through in the direction normal to the top surface 12 can be regarded, for example, as the center of a maximum inscribed circle in the inner periphery 22d of the winding portion 22. Alternatively, the imaginary line L1 can be positioned at the center of the main body 2 in the direction DL.

The second side gap LSG is a sum of a length LSG1 and a length LSG2 of two second side-gap portions 30c and 30d formed between the outer periphery 22c of the winding portion 22 and respective end surfaces 14 of the main body 2. The second side-gap portions 30c and 30d are portions of the core 30. The lengths LSG1 and LSG2 are lengths of the second side-gap portions 30c and 30d in the direction DL. More specifically, the length LSG1 of the second side-gap portion 30c is defined as a minimum distance in the direction DL between the outer periphery 22c of the winding portion 22 and one of the end surfaces 14 when the main body 2 is viewed through in the direction normal to the top surface 12. Similarly, the length LSG2 of the second side-gap portion 30d is defined as a minimum distance in the direction DL between the outer periphery 22c of the winding portion 22 and the other one of the end surfaces 14 when the main body 2 is viewed through in the direction normal to the top surface 12. Note that as illustrated in FIG. 5, each extension portion 23 is extended from the outer periphery 22c of the winding portion 22 to the corresponding end surface 14 of the main body and a connection portion between the extension portion 23 and the winding portion 22 is not included in forming the outer periphery 22c. More specifically, a portion of the outermost turn of which the surface facing the winding axis Q is detached from the turn adjoining the outermost turn is not included in forming the outer periphery 22c.

Alternatively, for example, the lengths LSG1 and LSG2 can be obtained by measuring the distances, along an imaginary line L2, between the outer periphery 22c of the winding portion 22 and the corresponding end surfaces 14 when the main body 2 is viewed through in the direction normal to the top surface 12 as illustrated in FIG. 5. The imaginary line L2 is an imaginary straight line extending in the direction DL so as to pass through the winding axis Q of the winding portion 22 when the main body 2 is viewed through in the direction normal to the top surface 12. The results obtained by measuring the lengths LSG1 and LSG2 in this manner can be close enough to the minimum distances in the direction DL between the outer periphery 22c of the winding portion 22 and respective end surfaces 14 when the main body 2 is viewed through in the direction normal to the top surface 12. Note that the imaginary line L2 can be positioned at the center of the main body 2 in the direction DW.

### Preferable Range of Parameter

Regarding parameters, the inventors found a preferable range of the value K obtained by the formula (1) below based on Example (to be described later) prepared by the inventors. In order to maximize Isat/Rdc, the preferable range of the value K is 70 or more and 110 or less (i.e., from 70 to 110). More preferably, the range of the value K is 80 or more and 100 or less (i.e., from 80 to 100).

$$\begin{matrix}K = S 1 / ( WSG \times LSG ) \times ( S 4 / S 3 ) \\ = ( S 1 / SG ) \times ( S 4 / S 3 ) \\ = B \times S 2\end{matrix} \qquad ( 1 )$$

In the present embodiment, the value K is 70 or more and 110 or less (i.e., from 70 to 110). As a result, Isat/Rdc of the inductor 1 can increase, resulting in the inductor 1 having better characteristics.

### Example

The inventors carried out experiments to inspect the relationship between the characteristics of the inductor and above-described parameters. In Example, the inventors prepared one main body 2 and calculated values K while the parameters were adjusted in simulation based on the main body 2 prepared. The inventors calculated Isat/Rdc with each value K to obtain a preferable range of the value K. The following describes details.

### Preparation of Sample

The inventors prepared a main body 2 for the simulation. The inventors prepared the mixed powder for the core 30 that included the metal magnetic powder containing Fe—Si—Cr alloy powder, which serves as the first magnetic particles, mixed with carbonyl iron powder, which serves as the second magnetic particles. In the metal magnetic powder of Example, the average grain diameter of the first magnetic particles was 25.3 μm and the average grain diameter of the second magnetic particles was 1.7 μm according to measurement results using a particle distribution analyzer. The resin of the mixed powder of Example contained bis-phenol A epoxy resin and rubber-modified epoxy resin, and the weight content of the resin is 2.7 wt % of the mixed powder. According to the measurement of the inventors, the mixed powder exhibited a relative magnetic permeability of 34 and a saturation magnetic flux density of 1.36 T. The relative magnetic permeability was measured using a B—H analyzer and an impedance/material analyzer at a frequency of 1 MHz. The saturation magnetic flux density of the mixed powder was obtained such that the change of inductance at saturation was measured using an LCR meter and a DC power supply and that the saturation magnetic flux density was obtained by reverse calculation based on the B—H data when the magnetic flux saturated.

In Example, the inventors used a flat wire having a cross sectional dimensions of 0.128 mm and 0.083 mm for a coil conductor 20. The coil conductor 20 were formed so as to have the winding portion 22 wound in two tiers and the extension portions 23 as described in Embodiment 1.

In Example, the inventors prepared the main body 2 using the core 30 and the coil conductor 20 described above. During the pressure molding, the coil conductor 20 was placed on a type-E preliminary compact containing the metal magnetic powder and the resin same as those of the core 30 of Example. The coil conductor 20 was sandwiched between the type-E preliminary compact and a type-I preliminary compact made of the same materials and subsequently placed in the molding die. The type-E preliminary compact, the coil conductor 20, and the type-I preliminary compact were compressed and heated to produce the main body 2. Here, the coil conductor 20 was placed such that the winding axis Q of the winding portion 22 was aligned in a direction substantially normal to the bottom surface 10, which is the mounting surface of the main body 2.

This produced the main body 2 having a length L of 1.52 mm in the length direction DL, a width W of 1.35 mm in the width direction DW, and a thickness T of 0.57 mm in the thickness direction DT.

### Simulation

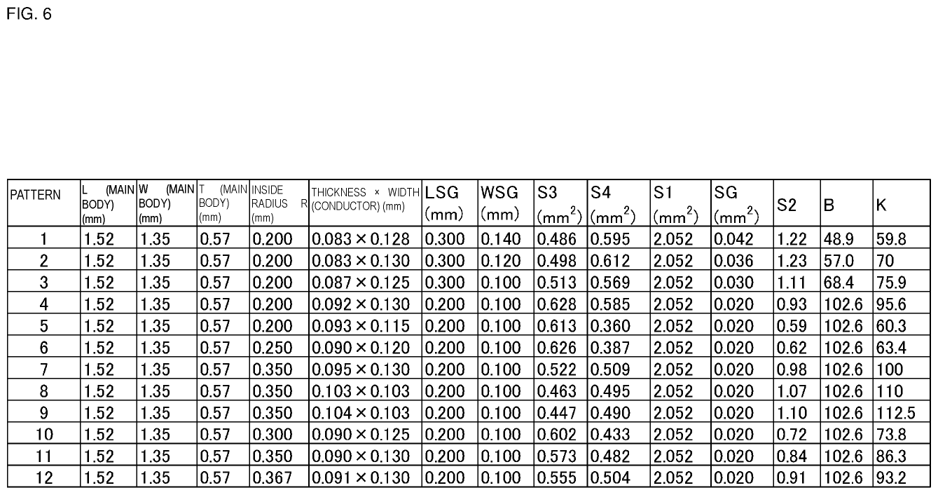

FIG. 6 is a table summarizing various parameters and calculated values K in the simulation. Note that labels of parameters in FIG. 6 correspond to those described in Embodiment 1. An inside radius R is the radius of curvature of a curved portion of the inner periphery 22d of the winding portion 22.

The inventors carried out the simulation based on the dimensions of the portions of the main body 2 obtained, and the value K was calculated for the main body 2 that has a first side gap WSG of 0.1 mm, a second side gap LSG of 0.2 mm, and an inside radius R of the coil conductor 20 of 0.25 mm. The resulted value K was 63.4.

Subsequently, the inventors calculated the value K in simulation in which the cross sectional dimensions of the flat wire, the inside radius R, the first side gap WSG, and the second side gap LSG were changed while the inductance was set to 0.31 pH. In addition, the outer dimensions of the main body 2 were fixed with a length L of 1.52 mm, a width W of 1.35 mm, and a thickness T of 0.57 mm. The results are collated in FIG. 6. In FIG. 6, the value K ranges from 59.8 or more and 112.5 or less (i.e., from 59.8 to 112.5) with 12 different patterns of parameter combination.

Note that although the above results are obtained from the simulation, the first side gap WSG and the second side gap LSG can be adjusted in the actual production by changing the size of the space in the molding die. Alternatively, a larger main body 2 can be obtained by setting the space of the molding die larger than the final product, and the first side gap WSG and the second side gap LSG can be adjusted by grinding the core 30 after pressure molding.

The inventors subsequently carried out simulation to investigate the change in Isat/Rdc at each value K in FIG. 6.

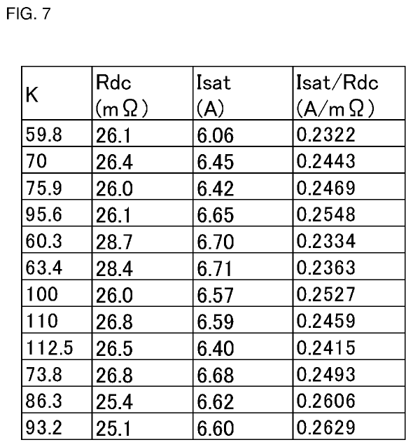

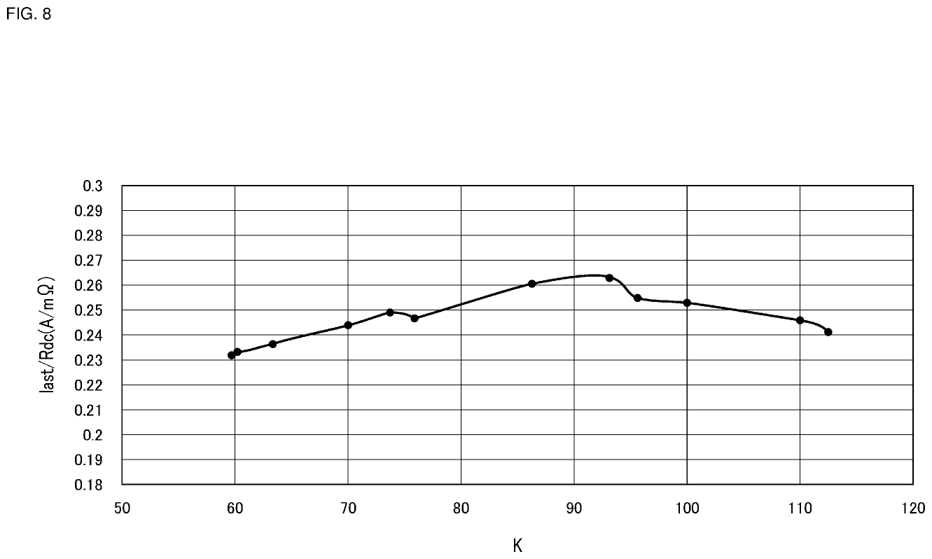

FIG. 7 is a table summarizing a relationship between the value K and Isat/Rdc in the simulation. FIG. 8 is a graph depicting the relationship between the value K and Isat/Rdc in the simulation. The curve in FIG. 8 is obtained by interpolating the simulation results summarized in FIG. 7.

As illustrated in FIGS. 7 and 8, Isat/Rdc exhibited a maximum in the case of the value K being 93.2 among the simulation results. With this value K, Isat/Rdc was 0.2629 A/mΩ. As illustrated in FIG. 7, Isat/Rdc has a peak value. Isat/Rdc tended to decrease from the peak value as the value K increased or decreased from that at the peak.

As illustrated in FIGS. 7 and 8, in the second simulation in Example, Isat/Rdc is 90% or more of the peak value in a range of the value K of 70 or more and 110 or less (i.e., from 70 to 110). Moreover, Isat/Rdc is 95% or more of the peak value in a range of the value K of 80 or more and 100 or less (i.e., from 80 to 100).

Accordingly, based on Example, the preferable range of the value K was found to be 70 or more and 110 or less (i.e., from 70 to 110) with the accuracy of actual measurement of parameters being taken into consideration. Based on Example, the more preferable range of the value K was found to be 80 or more and 100 or less (i.e., from 80 to 100).

The reason behind this phenomenon is not clear. However, it is necessary to adopt a design concept different from that adopted for a conventional inductor having a size of 1.4 mm by 1.2 mm or larger.

As illustrated in FIG. 7, Isat/Rdc has the peak value with respect to the value K. The possible reason for this is that the value B and the value S2 in the formula (1) above have separate preferable ranges for increasing Isat/Rdc.

When the value S2 is large, the outer area S4 is large, and the inner area S3 is small. When the outer area S4 is large, the diameter of the outer periphery 22c is small. Accordingly, the length of the conducting wire of the coil conductor 20 tends to become shorter, and Rdc tends to become small. On the other hand, the small inner area S3 causes the magnetic saturation to occur easily, which tends to decrease Isat.

When the value S2 is small, the outer area S4 is small, and the inner area S3 is large. When the outer area S4 is small, the diameter of the outer periphery 22c is large. Accordingly, the length of the conducting wire of the coil conductor 20 tends to become longer, and Rdc tends to become large. On the other hand, the magnetic saturation does not occur easily due to a large inner area S3, which tends to increase Isat.

Accordingly, in the case of the value S2 being large, both Rdc and Isat tend to become small, whereas in the case of the value S2 being small, both Rdc and Isat tend to become large. Accordingly, Isat/Rdc does not increase or decrease linearly with respect to the value S2, and the value S2 has a preferable range in which Isat/Rdc increases.

Regarding the value B, the next formula (2) can be obtained since the total area S1 is regarded as a product of the width W and the length L.

$$\begin{matrix}B = S 1 / SG \\ = ( W \times L ) / ( WSG \times LSG ) \\ = ( W / WSG ) \times ( L / LSG )\end{matrix} \qquad ( 2 )$$

Accordingly, the value B is regarded as a product of the reciprocal of the ratio of the first side gap WSG to the width W, or WSG/W, and the reciprocal of the ratio of the second side gap LSG to the length L, or LSG/L.

When the value B is large, the ratio WSG/W and the ratio LSG/L are small. In this case, the outer periphery 22c of the winding portion 22 is positioned close to the side surfaces 16 and the end surfaces 14 of the main body 2 when the main body 2 is viewed through in the direction normal to the top surface 12. In this case, the conducting wire of the coil conductor 20 tends to become longer, leading to an increase in Rdc. The diameter of the inner periphery 22d of the winding portion 22 tends to become larger. Accordingly, the magnetic saturation does not occur easily, and Isat tends to become larger.

When the value B is small, the ratio WSG/W and the ratio LSG/L are large. In this case, the outer periphery 22c of the winding portion 22 is positioned away from the side surfaces 16 and the end surfaces 14 of the main body 2 when the main body 2 is viewed through in the direction normal to the top surface 12. In this case, the conducting wire of the coil conductor 20 tends to become shorter, leading to a decrease in Rdc. The diameter of the inner periphery 22d of the winding portion 22 tends to become smaller. Accordingly, the magnetic saturation tends to occur easily, and Isat tends to become smaller.

Accordingly, in the case of the value B being large, both Rdc and Isat tend to become large, whereas in the case of the value B being small, both Rdc and Isat tend to become small. Accordingly, Isat/Rdc does not increase or decrease linearly with respect to the value B. The value B has a preferable range in which Isat/Rdc increases.

As discussed above, the value B and the value S2 has separate preferable ranges to increase Isat/Rdc. The value K is a product of the value B and the value S2 and has a preferable range in which Isat/Rdc increases.

### Embodiment 2

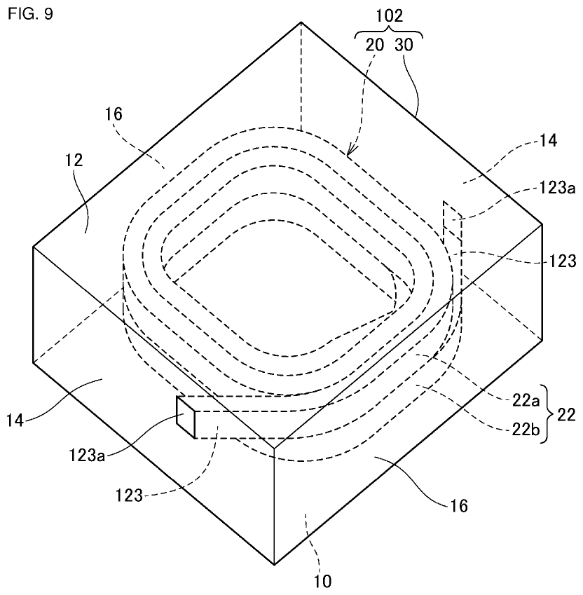

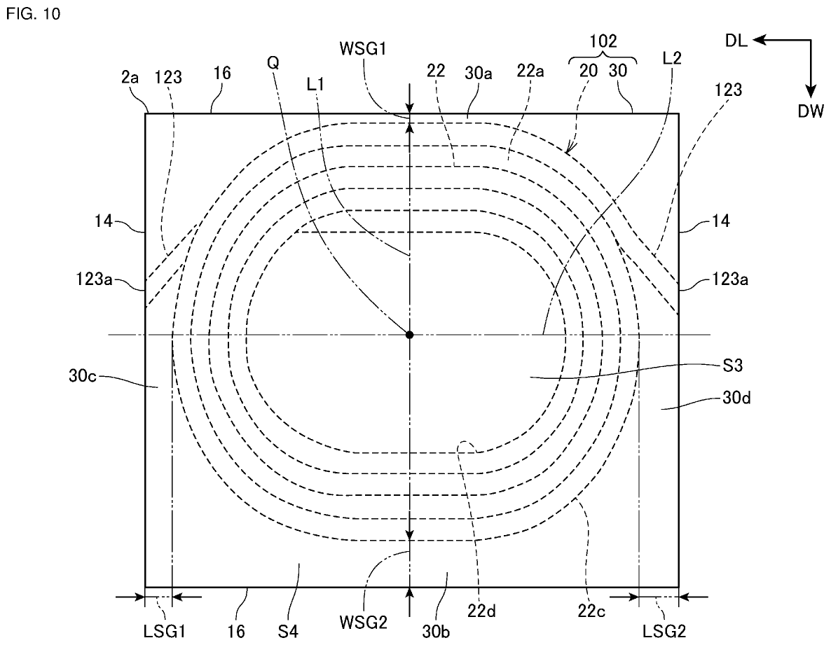

Embodiment 2 will be described with reference to FIGS. 9 and 10. Note that the following description focuses on differences from Embodiment 1, while the same descriptions will be omitted.

FIG. 9 is a perspective view illustrating a main body 102 according to Embodiment 2. FIG. 9 is a view schematically illustrating the main body 102, which is viewed through in the direction normal to the top surface 12.

The main body 102 of Embodiment 2 is different from the main body 2 of Embodiment 1 in that a section 123a of each extension portion 123 of the coil conductor 20 is exposed at each end surface 14 in the main body 102. More specifically, the section 123a of each extension portion 123 of the conducting wire is flush with the corresponding end surface 14 of the main body 102. In other words, the section 123a of the extension portion 123 of the conducting wire and the corresponding end surface 14 of the main body 102 are positioned substantially on the same plane. For example, the section 123a of the extension portion 123 of the conducting wire can be exposed from the corresponding end surface 14 of the main body 102 and can be flush with the end surface 14 by grinding each end surface 14, together with the extension portion 123, in the direction DL in the step of grinding the main body. Note that the sections 123a of the extension portions 123 of the conducting wire exposed from the end surfaces 14 of the main body 102 are connected to respective outer electrodes 4 in the step of forming the outer electrodes.

Accordingly, the sections 123a of the extension portions 123 of the conducting wire are exposed at respective end surfaces 14 of the main body 102 by grinding the end surfaces 14. With this configuration, the lengths LSG1 and LSG2 of the second side-gap portions 30c and 30d can be adjusted easily. As a result, the value K calculated from the formula (1) above can be adjusted easily into a range of 70 or more and 110 or less (i.e., from 70 to 110).

### Embodiment 3

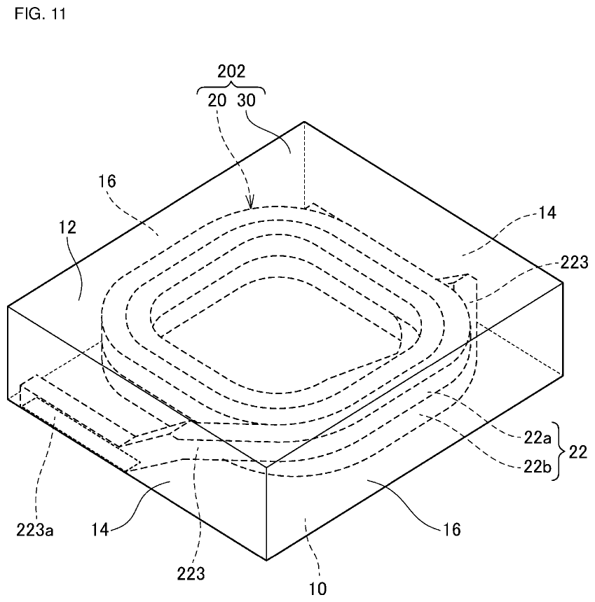

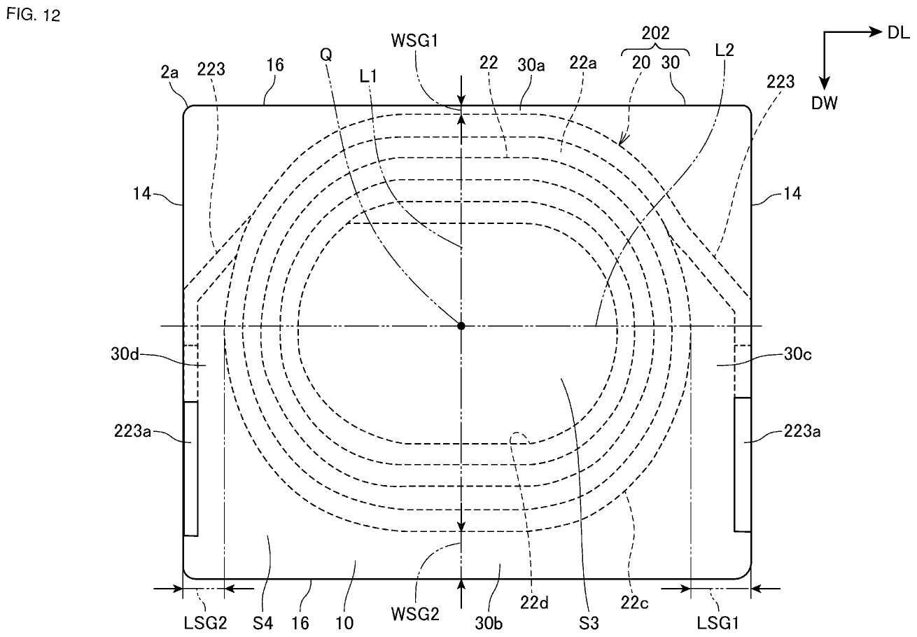

Embodiment 3 will be described with reference to FIGS. 11 and 12. Note that the following description focuses on differences from Embodiments 1 and 2, while the same descriptions will be omitted.

FIG. 11 is a perspective view illustrating a main body 202 according to Embodiment 3. FIG. 12 is a view schematically illustrating the main body 202, in which a bottom surface 10 thereof is viewed.

In the main body 202 of Embodiment 3, two extension portions 223 of the coil conductor 20 are bent toward bottom surface 10 and exposed at the bottom surface 10, which is different from Embodiments 1 and 2. More specifically, surfaces 223a of the extension portions 223 of the conducting wire are exposed at the bottom surface 10 of the main body 202. Note that the surfaces 223a of the extension portions 223 of the conducting wire exposed from the bottom surface 10 of the main body 202 are connected to respective outer electrodes 4 in the step of forming the outer electrodes.

Accordingly, the surfaces 223a of the extension portions 223 of the conducting wire are exposed from the bottom surface 10 of the main body 202, and the extension portions 223 can be connected to the outer electrodes 4 even if the extension portions 223 are not exposed at the end surfaces 14. This eliminates the necessity of the extension portions 223 being exposed at the end surfaces 14 of the main body 202, which can increase the degree of freedom in adjusting the lengths LSG1 and LSG2 of the second side-gap portions 30c and 30d. As a result, the value K calculated from the formula (1) above can be adjusted easily into a range of 70 or more and 110 or less (i.e., from 70 to 110).

### OTHER EMBODIMENTS

In the description of the above embodiments, each outer electrode 4 is the L-shaped electrode formed so as to extend from the end surface 14 to the bottom surface 10 of the main body 2, 102, or 202, but the shape of the outer electrode 4 is not limited to this example. Each outer electrode 4 may be formed so as to cover each end surface 14 of the main body 2, 102, or 202 and also extend into the bottom surface 10, the top surface 12, and two side surfaces 16 that adjoin the end surface 14. In this case, the surfaces 223a of the extension portions 223 of the conducting wire as described in Embodiment 3 may be exposed at the top surface 12 of the main body 202, instead of at the bottom surface 10.

In the description of the above embodiments, two first side-gap portions 30a and 30b are formed between the winding portion 22 and respective side surfaces 16. The first side-gap portions 30a and 30b are not limited to this example. For example, the outer periphery 22c of the winding portion 22 may be exposed from one of the side surfaces 16, and accordingly only one of the first side-gap portions 30a and 30b is provided. In this case, the first side gap WSG is equal to either the width WSG1 or the width WSG2. Similarly, the winding portion 22 may be exposed at one of the end surfaces 14, and accordingly only one of the second side-gap portions 30c and 30d may be formed between the winding portion 22 and one of the end surfaces 14. In this case, the second side gap LSG is equal to either the length LSG1 or the length LSG2.

Note that above embodiments and alterations are examples provided to describe some aspects of the present disclosure and may be changed and modified appropriately without departing from the scope of the present disclosure. Any elements contained in the above embodiments can be combined appropriately, and such combinations may form new embodiments.

In the above embodiments, concepts related to direction, such as “horizontal”, “orthogonal”, or “vertical”, or numbers, shapes, or materials may encompass equivalents that can provide similar effects.

### Features Supported by Above Embodiments

The above-described embodiments supports the following features.

### Feature 1

An inductor includes a coil, a main body, and outer terminals. The coil includes a winding portion formed by winding a flat conducting wire and also includes a pair of extension portions of the conducting wire extended from the winding portion. The main body contains magnetic powder and resin and accommodates the coil. The outer terminals are formed on at least one surface of the main body and connected to respective extension portions. In the inductor, the main body includes a principal surface shaped like a rectangle having sides extending in a first direction and in a second direction, and the principal surface intersects a winding axis of the coil. The main body also includes a pair of first surfaces adjoining the principal surface and extending in the first direction and a pair of second surfaces adjoining the principal surface and extending in the second direction. The main body also includes first side-gap portions formed between an outer periphery of the winding portion and respective first surfaces and second side-gap portions formed between the outer periphery and respective second surfaces. When S1 is an area of the principal surface, WSG is a sum of lengths of respective first side-gap portions in the second direction, LSG is a sum of lengths of respective second side-gap portions in the first direction, S3 is an area surrounded by an inner periphery of the winding portion as viewed in a direction normal to the principal surface, S4 is an area between the outer periphery and a periphery of the main body as viewed in the direction normal to the principal surface, and SG is a value obtained from formula (A) below, K obtained from formula (B) below stays in a range of 70 or more and 110 or less (i.e., from 70 to 110).

$$SG = WSG \times LSG \qquad ( A )$$

$$K = ( S 1 / SG ) \times ( S 4 / S 3 ) \qquad ( B )$$

According to the inductor described in Feature 1, Isat/Rdc can increase. As a result, the inductor having favorable characteristics can be provided.

### Feature 2

In the inductor according to Feature 1 above, a section of each extension portion of the conducting wire is exposed from each second surface, and the section is flush with the second surface.

According to the inductor described in Feature 2, the length of the second side-gap portion in the first direction can be adjusted easily, and the value K can be adjusted easily into the range of 70 or more and 110 or less (i.e., from 70 to 110). As a result, the inductor having favorable characteristics can be provided.

### Feature 3

In the inductor according to Feature 1 or 2 above, a surface of each extension portion of the conducting wire is exposed from the principal surface.

The inductor described in Feature 3 can increase the degree of freedom in changing the length of the second side-gap portion in the first direction, which enables the value K to be adjusted easily into the range of 70 or more and 110 or less (i.e., from 70 to 110). As a result, the inductor having favorable characteristics can be provided.

What is claimed is:

1. An inductor comprising:
a coil including
a winding portion including a flat conducting wire that is wound, and
a pair of extension portions of the conducting wire extended from the winding portion;
a main body including magnetic powder and resin and accommodating the coil; and
outer terminals on at least one surface of the main body and connected to respective extension portions, wherein
the main body includes
a principal surface shaped like a rectangle having sides extending in a first direction and in a second direction, the principal surface intersecting a winding axis of the coil,
a pair of first surfaces adjoining the principal surface and extending in the first direction,
a pair of second surfaces adjoining the principal surface and extending in the second direction,
first side-gap portions between an outer periphery of the winding portion and respective first surfaces, and
second side-gap portions between the outer periphery and respective second surfaces, and
when S1 is an area of the principal surface, WSG is a sum of lengths of respective first side-gap portions in the second direction, LSG is a sum of lengths of respective second side-gap portions in the first direction, S3 is an area surrounded by an inner periphery of the winding portion as viewed in a direction normal to the principal surface, S4 is an area between the outer periphery and a periphery of the main body as viewed in the direction normal to the principal surface, SG is a value obtained from formula (A) below, and K obtained from formula (B) below stays in a range of from 70 to 110
$$SG = WSG \times LSG \qquad ( A )$$
$$K = ( S 1 / SG ) \times ( S 4 / S 3 ) . \qquad ( B )$$

2. The inductor according to claim 1, wherein
a section of each extension portion of the conducting wire is exposed from each second surface, and
the section is flush with the second surface.

3. The inductor according to claim 1, wherein
a surface of each extension portion of the conducting wire is exposed from the principal surface.

4. The inductor according to claim 2, wherein
a surface of each extension portion of the conducting wire is exposed from the principal surface.
